(19) United States
(12) Patent Application Publication
(10) Pub. No.: US 2012/0111204 A1
(43) Pub. Date: May 10, 2012

(54) Heating cooker

(75) Inventors: June Hoe Choi, Suwon-si (KR); Ki Hong Noh, Seoul (KR); Jeong Su Han, Suwon-si (KR); Ji Hoon Ha, Suwon-si (KR); Tae Gyoon Noh, Suwon-si (KR)

(73) Assignee: SAMSUNG ELECTRONICS CO., LTD., Suwon-si (KR)

(21) Appl. No.: 13/317,362

(22) Filed: Oct. 17, 2011

(30) Foreign Application Priority Data
Nov. 5, 2010 (KR) 10-2010-0109912

(51) Int. Cl. A47J 37/06; G01J 5/00; G01K 13/00

(52) U.S. Cl. 99/331; 374/149; 250/338.1; 374/E13.001

(57) ABSTRACT

A heating cooker having an infrared ray detection device. The heating cooker includes a main body, an inner case disposed within the main body such that a cooking chamber to cook food is provided within the inner case, a detection hole formed on one side wall of the inner case to discharge infrared rays generated from the cooking chamber to the outside of the cooking chamber, a path change unit disposed around the detection hole to change paths of the infrared rays having passed through the detection hole, and an infrared ray sensor separated from the path change unit by a designated distance to receive the infrared rays, the paths of which have been changed, wherein the path change unit is rotatably provided so that infrared rays generated from different regions of the cooking chamber and traveling on different paths are received by the infrared ray sensor.

### CROSS-REFERENCE TO RELATED APPLICATION

This application claims the benefit of Korean Patent Application No. 2010-0109912, filed on Nov. 5, 2010 in the Korean Intellectual Property Office, the disclosure of which is incorporated herein by reference.

### BACKGROUND

1. Field

Embodiments of the present invention relate to a heating cooker having an infrared ray detection device.

2. Description of the Related Art

Heating cookers are apparatuses which raise a temperature of food so as to cook the food. In general, heating cookers include microwave ovens which irradiate microwaves to food and gas ovens and electric ovens which apply heat directly to food. A microwave oven irradiates microwaves generated from a magnetron to food and thus cooks the food using frictional heat generated due to translational motion of water molecules contained in the food.

A cooked state of food is detected by measuring a temperature of the food, and direct measurement of the temperature of the food during cooking of the food is difficult. Therefore, a method in which an intensity of infrared rays generated from food is measured and a temperature of the food is calculated using the measured intensity of infrared rays is used. In order to measure an intensity of infrared rays, an infrared ray sensor is generally used. Such an infrared ray sensor is configured such that a light reception unit to receive infrared rays is disposed around a measurement hole formed on a cooking chamber so as to be positioned opposite the cooking chamber.

However, since the light reception unit is positioned opposite the cooking chamber, the light reception unit may be contaminated by oil or steam generated from food. Further, in case of a microwave oven, microwaves irradiated to the inside of a cooking chamber reach the light reception unit and may thus lower reliability of a measurement result.

### SUMMARY

Therefore, it is an aspect of the present invention to provide a heating cooker having an infrared ray detection device using a reflecting mirror.

Additional aspects of the invention will be set forth in part in the description which follows and, in part, will be obvious from the description, or may be learned by practice of the invention.

In accordance with one aspect of the present invention, a heating cooker includes a main body, an inner case disposed within the main body such that a cooking chamber to cook food is provided within the inner case, a detection hole formed on one side wall of the inner case to discharge infrared rays generated from the cooking chamber to the outside of the cooking chamber, a path change unit disposed around the detection hole to change paths of the infrared rays having passed through the detection hole, and an infrared ray sensor separated from the path change unit by a designated distance to receive the infrared rays, the paths of which have been changed, wherein the path change unit is movably provided so that infrared rays generated from different regions of the cooking chamber and traveling on different paths are received by the infrared ray sensor.

The separation distance between the path change unit and the infrared ray sensor may be regularly maintained when the path change unit is moved.

The detection hole may be formed on one of a left wall and a right wall of the inner case and be located closer to an upper wall of the inner case than to a lower wall of the inner case.

The path change unit may include a reflecting mirror to reflect the infrared rays so as to change the paths of the infrared rays.

The heating cooker may further include a drive device connected to the path change unit to rotate the path change unit.

The drive device may include a stepping motor to rotate the path change unit by a designated angle.

The separation distance between the path change unit and the infrared ray sensor may be less than 20 mm.

The infrared ray sensor may include a light reception unit positioned opposite the path change unit to receive the infrared rays, and the path change unit may be rotated around a virtual rotation axis perpendicular to the light reception unit.

When the path change unit is rotated, infrared rays generated from a region between two opposite edges of the bottom of the cooking chamber may be received by the infrared ray sensor.

The infrared ray sensor may include a light reception unit positioned opposite the path change unit to receive the infrared rays, and the path change unit may be rotated around a rotation axis perpendicular to a virtual axis perpendicular to the light reception unit.

In accordance with another aspect of the present invention, an infrared ray detection device includes a path change unit provided to change paths of infrared rays and an infrared ray sensor separated from the path change unit by a designated distance to receive the infrared rays, the paths of which have been changed, wherein the path change unit is rotatable so that infrared rays traveling on different paths are received by the infrared ray sensor.

The separation distance between the path change unit and the infrared ray sensor may be regularly maintained when the path change unit is rotated.

The separation distance between the path change unit and the infrared ray sensor may be less than 20 mm.

The infrared ray sensor may include a light reception unit positioned opposite the path change unit, and the path change unit may be rotated around a virtual axis perpendicular to the light reception unit.

The infrared ray sensor may include a light reception unit positioned opposite the path change unit to receive the infrared rays, and the path change unit may be rotated around a rotation axis perpendicular to a virtual axis, which passes through the light reception unit perpendicularly to the light reception unit.

In accordance with another aspect of the present invention, a heating cooker includes a main body, an inner case disposed within the main body such that a cooking chamber to cook food is provided within the inner case, a detection hole formed on one side wall of the inner case to discharge infrared rays generated from the cooking chamber to the outside of the cooking chamber, a path change unit disposed around the detection hole to change paths of the infrared rays having passed through the detection hole, and an infrared ray sensor separated from the path change unit by a designated distance to receive the infrared rays, the paths of which have been changed, wherein the path change unit is rotatably provided so that infrared rays generated from different regions of the cooking chamber and traveling on different paths are received by the infrared ray sensor, and the path change unit is rotated around a virtual axis perpendicular to the light reception unit.

In accordance with a further aspect of the present invention, a method of measuring a temperature of a cooking chamber of a heating cooker, including the cooking chamber, a path change unit disposed at the outside of the cooking chamber and rotatably provided to change paths of infrared rays generated from the cooking chamber, and an infrared ray sensor to receive the infrared rays, the paths of which have been changed, includes rotating the path change unit to a first position so that infrared rays generated from a first region of the bottom of the cooking chamber are received by the infrared ray sensor, rotating the path change unit to a second position so that infrared rays generated from a second region of the bottom of the cooking chamber are received by the infrared ray sensor, measuring intensities of the infrared rays generated from the first and second regions and then received by the infrared ray sensor, and calculating temperatures of the first and second regions using the measured intensities of the infrared rays.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view of a microwave oven in accordance with an embodiment of the present invention;

FIG. 2 is an exploded perspective view of the microwave oven shown in FIG. 1;

FIG. 3 is a view illustrating an infrared ray detection device mounted on a cooking chamber of the microwave oven in accordance with an embodiment of the present invention;

FIG. 4 is a perspective view of the infrared ray detection device in accordance with an embodiment of the present invention;

FIG. 5 is a cross-sectional view of the infrared ray detection shown in FIG. 4;

FIG. 6 is a perspective view of an infrared ray detection device in accordance with an embodiment of the present invention;

FIG. 7 is a view illustrating operation of the infrared ray detection device shown in FIG. 4; and

FIG. 8 is a view illustrating operation of the infrared ray detection device shown in FIG. 6.

### DESCRIPTION OF EMBODIMENTS

Reference will now be made in detail to embodiments of the present invention, examples of which are illustrated in the accompanying drawings, wherein like reference numerals refer to like elements throughout.

Embodiments of the present invention may be any heating cooker having a cooking chamber. Hereinafter, a microwave oven will be exemplarily described.

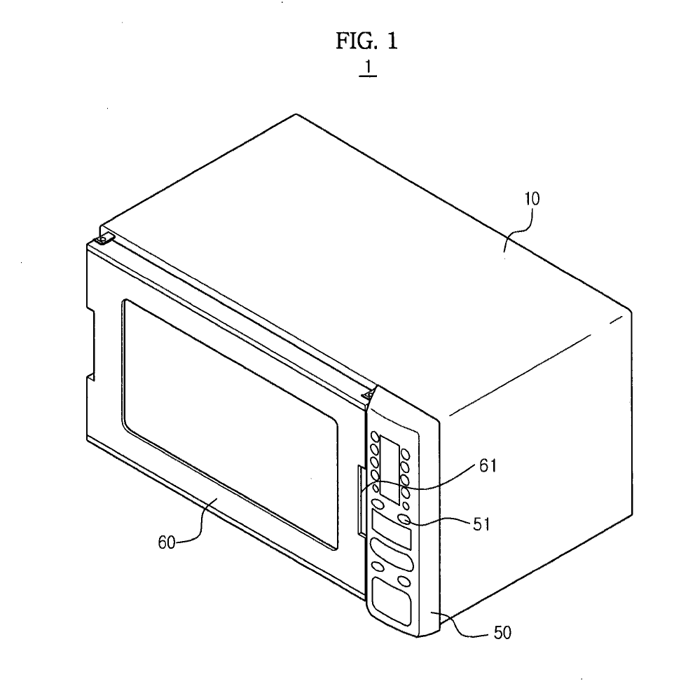

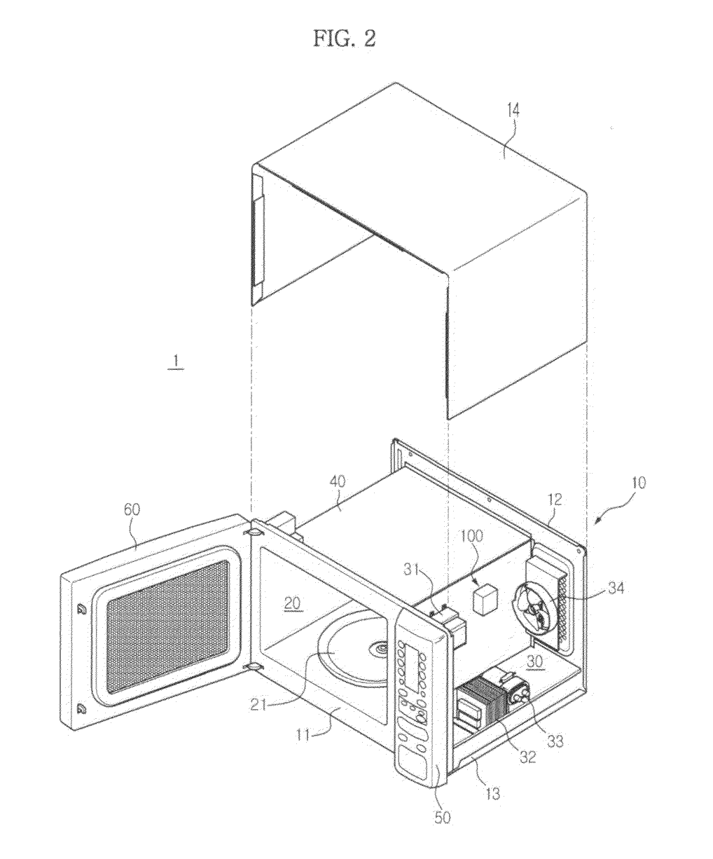

FIG. 1 is a perspective view of a microwave oven in accordance with one embodiment of the present invention and FIG. 2 is an exploded perspective view thereof.

As shown in FIGS. 1 and 2, a microwave oven 1 includes a main body 10 forming the external appearance of the microwave oven 1. The main body 10 includes a front plate 11 and a rear plate 12 forming front and rear surfaces, a bottom plate 13 forming a bottom surface, and a cover 14 forming both side surfaces and an upper surface.

An inner case 40 has a rectangular parallelepipedal shape with an opened front surface and an internal space forming a cooking chamber 20. An external space of the inner case 40 forms an electrical component chamber 30 within the main body 10. A door 60 is hinged to the front plate 11 to open and close the cooking chamber 20 and an operating panel 50 is provided on the front plate 11 with a plurality of operating buttons 51 to control the overall operation of the microwave oven 1.

A magnetron 31 to generate high frequency microwaves to be supplied to the inside of the cooking chamber 20, a high voltage transformer 32, a high voltage condenser 33 to apply high voltage to the magnetron 31, and a cooling fan 34 to cool the respective components in the electrical component chamber 30 are provided in the electrical component chamber 30 located at the right of the cooking chamber 20. A tray 21 is installed on the bottom of the cooking chamber 20 and food to be cooked is placed on the tray 21. A waveguide (not shown) to guide the high frequency-microwaves emitted from the magnetron 31 to the inside of the cooking chamber 20 is installed in the cooling chamber 20.

When the microwave oven 1 is driven to emit high frequency microwaves to the inside of the cooking chamber 20 under the condition that food is placed on the tray 21, the food is cooked using frictional force between molecules caused by repeated change of the molecular alignment of water contained in the food.

A cooked state of the food may be detected by measuring a temperature of the food. The temperature of the food is calculated by measuring an intensity of infrared rays generated from the food. Therefore, the microwave oven 1 includes an infrared ray detection device 100 to measure the intensity of infrared rays generated from the inside of the cooking chamber 20.

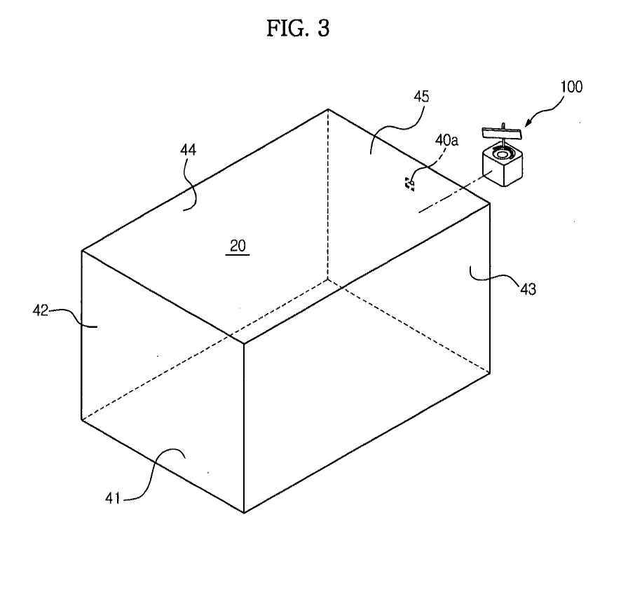

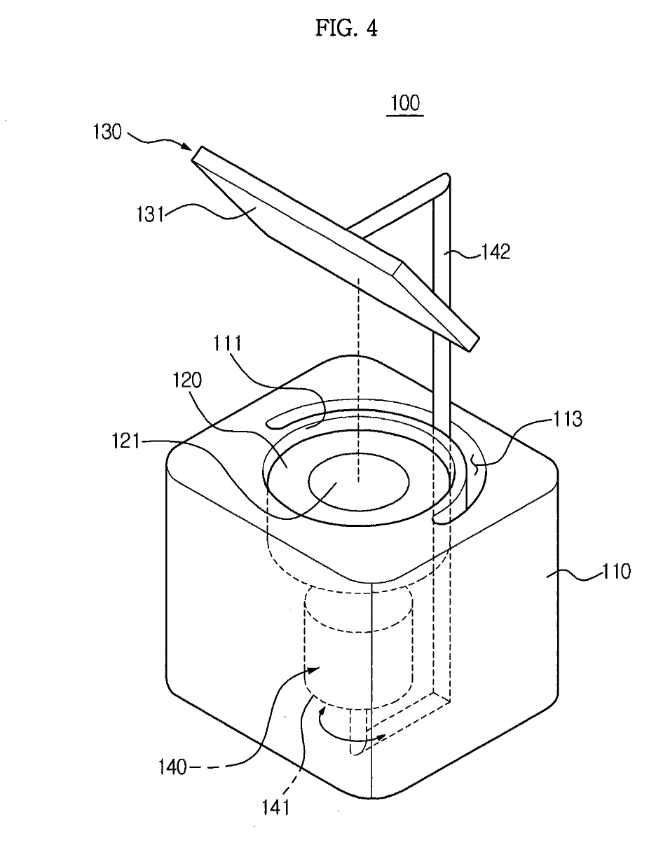

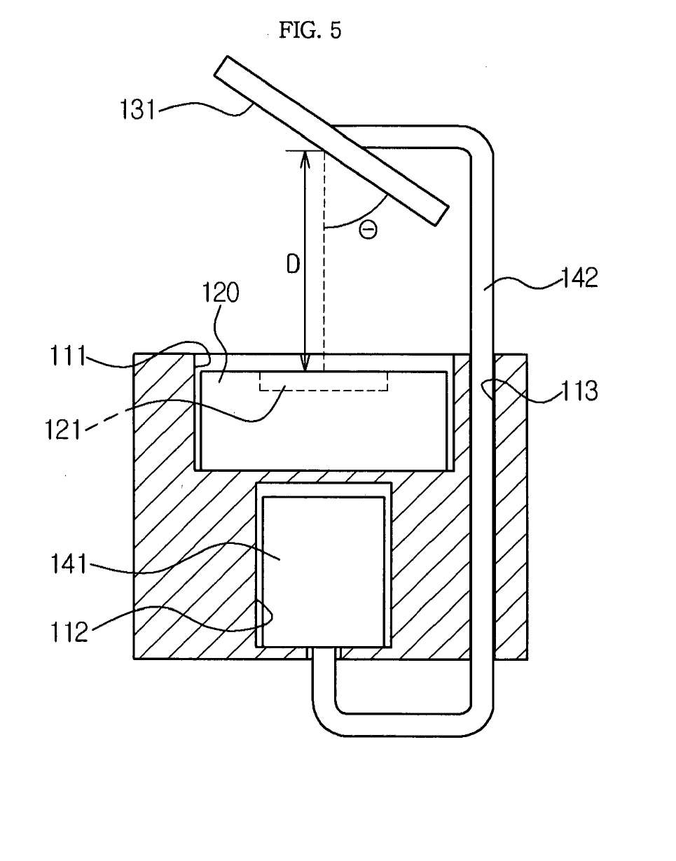

FIG. 3 is a view illustrating the infrared ray detection device mounted on the cooking chamber of the microwave oven in accordance with an embodiment of the present invention, FIG. 4 is a perspective view of the infrared ray detection device in accordance with an embodiment of the present invention, and FIG. 5 is a cross-sectional view of the infrared ray detection device shown in FIG. 4

As shown in FIGS. 3 to 5, the infrared ray detection device 100 is disposed at the outside of the inner case 40. A detection hole 40a through which infrared rays generated from the cooking chamber 20 are discharged to the outside of the cooking chamber 40 is formed on the inner case 40. The infrared ray detection device 100 is disposed around the detection hole 40a so as to receive the infrared rays having passed through the detection hole 40a. The infrared ray detection device 100 is fixed to the inner case 40 by fastening members, such as screws.

The detection hole 40a is formed on a right wall 43 of the inner case 40. However, the position of the detection hole 40a is not limited thereto. For example, the detection hole 40a may be formed on a left wall 42, a right wall 43 a rear wall 44 or an upper wall 45 of the inner case 40. Since the infrared ray detection device 100 is disposed around the detection hole 40a, the position of the detection hole 40a is restricted by whether or not a space occupied by the infrared ray detection device 100 is assured.

If the detection hole 40a is formed on one of the left wall 42, the right wall 43 and the rear wall 44 of the inner case 40, the detection hole 40a is preferably located closer to the upper wall 45 than to the lower wall 41. The detection hole 40a may be configured such that the detection hole 40a is communicated with the upper portion of the space of the cooking chamber 20 so that infrared rays generated from the entirety of the lower portion of the cooking chamber 20, in which food is placed, pass through the detection hole 40a and are received by the infrared ray detection device 100.

The detection hole 40a may be formed in a rectangular shape, a circular shape or an oval shape.

The infrared ray detection device 100 includes a housing 110, an infrared ray sensor 120, a path change unit 130, and a drive device 140.

The housing 110 forms the external appearance of the infrared ray detection device 100. A sensor mount part 111 on which the infrared ray sensor 120 is mounted is formed on the housing 110. The sensor mount part 111 is provided with an opened upper portion and is formed in a shape corresponding to the infrared ray sensor 120. Further, a drive device mount part 112 on which the drive device 140 is mounted is formed on the housing 110. The drive device mount part 112 is provided below the sensor mount part 111. Moreover, a rotation guide groove 113 to guide rotation of a connection member 142, which will be described later, is formed on the housing 110.

The infrared ray sensor 120 has a cylindrical shape, and includes a light reception unit 121 to receive infrared rays formed on the upper surface thereof. The infrared ray sensor 120 is mounted on the sensor mount part 111 such that the light reception unit 121 faces upwards. Infrared ray detection elements (not shown) are disposed under the light reception unit 121. The infrared ray detection elements receive infrared rays and generate output corresponding to an intensity of the infrared rays. A plurality of the infrared ray detection elements is provided so as to respectively receive infrared rays generated from a plurality of regions of the cooking chamber 20 shown in FIG. 3.

The light reception unit 121 of the infrared ray sensor 120 is disposed so as to be separated from the detection hole 40a formed on the inner case 40 shown in FIG. 3 by a designated distance in the lengthwise direction of the external surface of the inner case 40. Therefore, a field of vision of the light reception unit 121 is not directly positioned opposite the detection hole 40a. Infrared rays which are generated from the cooking chamber 20 and pass through the detection hole 40a do not reach the light reception unit 121 unless paths of the infrared rays are changed. That is, the light reception unit 121 is not located on the paths of the infrared rays having passed through the detection hole 40a.

Further, since oil or steam generated from food during cooking may pass through the detection hole 40a, the infrared ray detection device 100 is disposed such that the light reception unit 121 is located under the detection hole 40a so as to prevent the oil or the steam having passed through the detection hole 40a from contaminating the light reception unit 121.

The path change unit 130 changes the path of the infrared rays having passed through the detection hole 40a of the inner case 40 so that the infrared rays the paths of which have been changed are received by the infrared ray sensor 120. Therefore, the path change unit 130 is located on the paths of the infrared rays having passed through the detection hole 40a. Further, the path change unit 130 is located above the infrared ray sensor 120 so that infrared rays, the paths of which have been changed, are received by the light reception unit 121 of the infrared ray sensor 120. The path change unit 130 reflects or refracts infrared rays so as to change paths of the infrared rays having straightness.

The path change unit 130 includes a reflecting mirror 131 to reflect infrared rays incident at a designated incidence angle. The reflecting mirror 131 may be a planar mirror having an incidence angle and a reflection angle which are the same. Further, the reflecting mirror 131 may be a curved mirror having a designated curvature.

The reflecting mirror 131 is inclined at a designated angle with respect to the infrared ray sensor 120. That is, the reflecting mirror 131 is disposed at a designated angle θ with respect to a virtual axis which is perpendicularly extended upward from the light reception unit 121 of the infrared ray sensor 120. Such an angle θ may be regularly maintained while the path change unit 130 is rotated around the infrared ray sensor 120.

The reflecting mirror 131 is disposed such that the virtual axis perpendicularly extended upward from the center of the light reception unit 121 of the infrared ray sensor 120 passes through the central area of the reflecting mirror 131. Infrared rays having passed through the detection hole 40a are reflected by the central area of the reflecting mirror 131, and the reflected infrared rays reach the light reception unit 121.

The path change unit 130 is separated from the infrared ray sensor 120 by a designated distance D. The separation distance D between the central part of the path change unit 130 and the light reception unit 121 of the infrared ray sensor 120 is regularly maintained when the path change unit 130 is rotated around the infrared ray sensor 120.

The separation distance D is maintained by the size of the light reception unit 121 of the infrared ray sensor 120. Infrared rays generated from plural regions of the cooking chamber 20 are received by the light reception unit 121 after the paths of the infrared rays have been changed by the path change unit 130. If an area of the light reception unit 121 is large, all the infrared rays may reach the light reception unit 121 even if the separation distance D is somewhat long, but if the area of the light reception unit 121 is small, some of the infrared rays do not reach the light reception unit 121. Therefore, the separation distance D between the central part of the path change unit 130 and the light reception unit 121 of the infrared ray sensor 120 may be less than 20 mm in consideration of the general size of the infrared ray sensor 120.

The drive device 140 rotates the path change unit 130 around the infrared ray sensor 120. For this purpose, the drive device 140 includes the connection member 142 which connects an output unit of the drive device 140 to the path change unit 130. The rotation guide groove 113 having an arc shape to guide rotation of the connection member 142 is formed on the housing 110, and the connection member 142 is rotated along the rotation guide groove 131.

The drive device 140 includes a stepping motor 141 rotated in stages. The stepping motor 141 rotates the path change unit 130 in stages so that infrared rays generated from the entirety of the bottom surface of the cooking chamber 20 are received by the infrared ray sensor 120.

Viewing the cooking chamber 20 through the detection hole 40a from the position of the infrared ray detection device 100, when the drive device 140 rotates the path change unit 130, the bottom surface of the cooking chamber 20 from the left region of the bottom surface to the right region of the bottom surface or vice versa comes into view of the path change unit 130. Therefore, the paths of infrared rays generated from these regions are changed by the path change unit 130, and then the infrared rays, the paths of which have been changed, are received by the infrared ray sensor 120.

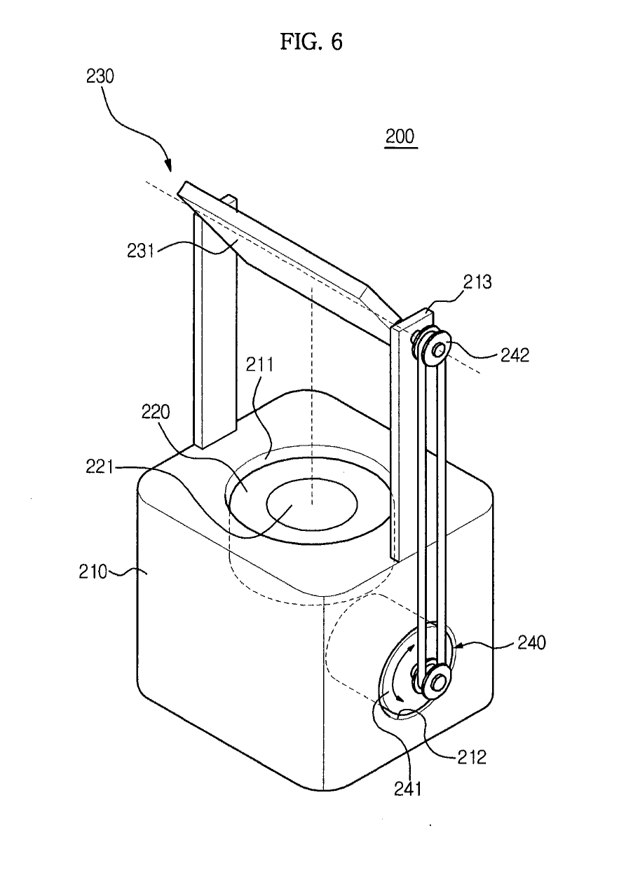

FIG. 6 is a perspective view of an infrared ray detection device in accordance with another embodiment of the present invention.

As shown in FIG. 6, the infrared ray detection device 200 includes a housing 210, an infrared ray sensor 220, a path change unit 230, and a drive device 240. The infrared ray sensor 220 in this embodiment shown in FIG. 6 is the same as the infrared ray sensor 120 in the former embodiment shown in FIGS. 4 and 5.

The housing 210 forms the external appearance of the infrared ray detection device 200. A sensor mount part 211 on which the infrared ray sensor 220 is mounted and a drive device mount part 212 on which the drive device 240 is mounted are formed on the housing 210. The drive device mount part 212 is formed on one side surface of the housing 210.

Support parts 213 to support the path change unit 230 extend upward from the housing 210. The support parts 213 respectively support both sides of the path change unit 230, and the path change unit 230 is rotatably connected to the support parts 213.

The path change unit 230 is located on paths of infrared rays having passed through the detection hole 40a of the inner case 40 shown in FIG. 3. The path change unit 230 reflects or refracts infrared rays so as to change the paths of the infrared rays. The path change unit 230 includes a reflecting mirror 231 having an incidence angle and a reflection angle which are the same.

The path change unit 230 is disposed such that a virtual axis perpendicularly extended upward from the center of a light reception unit 221 of the infrared ray sensor 220 passes through the central area of the reflecting mirror 231. Infrared rays having passed through the detection hole 40a are reflected by the central area of the reflecting mirror 231, and the reflected infrared rays reach the light reception unit 221.

The path change unit 230 is separated from the infrared ray sensor 220 by a designated distance. In the same manner as the path change unit 130 shown in FIGS. 4 and 5, the separation distance is maintained by the size of the light reception unit 221 of the infrared ray sensor 220. The separation distance between a rotation axis of the path change unit 230 and the light reception unit 221 of the infrared ray sensor 220 may be less than 20 mm in consideration of the general size of the infrared ray sensor 220.

The rotation axis of the path change unit 230 is perpendicular to the virtual axis perpendicularly extended upward from the light reception unit 221 of the infrared ray sensor 220. Therefore, an angle between a reflecting plane of the path change unit 230 and the virtual axis perpendicularly extended upward from the light reception unit 221 of the infrared ray sensor 220 is changed according to rotation of the path change unit 230.

The drive device 240 rotates the path change unit 230 around the rotation axis of the path change unit 230. The drive device 240 includes a power transmission unit 242 connecting an output unit of the drive device 240 to the rotation axis of the path change unit 230. The power transmission unit 242 includes a wire and pulleys.

The drive device 240 includes a stepping motor 241 rotated in stages. The stepping motor 241 rotates the path change unit 230 in stages so that infrared rays generated from the entirety of the bottom surface of the cooking chamber 20 are received by the infrared ray sensor 220.

Viewing the cooking chamber 20 through the detection hole 40a from the position of the infrared ray detection device 200, when the drive device 240 rotates the path change unit 230, the bottom surface of the cooking chamber 20 from a region of the bottom surface close to the infrared ray detection device 200 to a region of the bottom surface distant from the infrared ray detection device 200 or vice versa comes into view of the path change unit 230. Therefore, the paths of infrared rays generated from these regions are changed by the path change unit 230. If the paths of the infrared rays changed by the path change unit 230 are fixed, when the path change unit 230 is rotated by an angle of N degrees, a field of vision of the path change unit 230 to the cooking chamber 20 moves by an angle of 2N degrees.

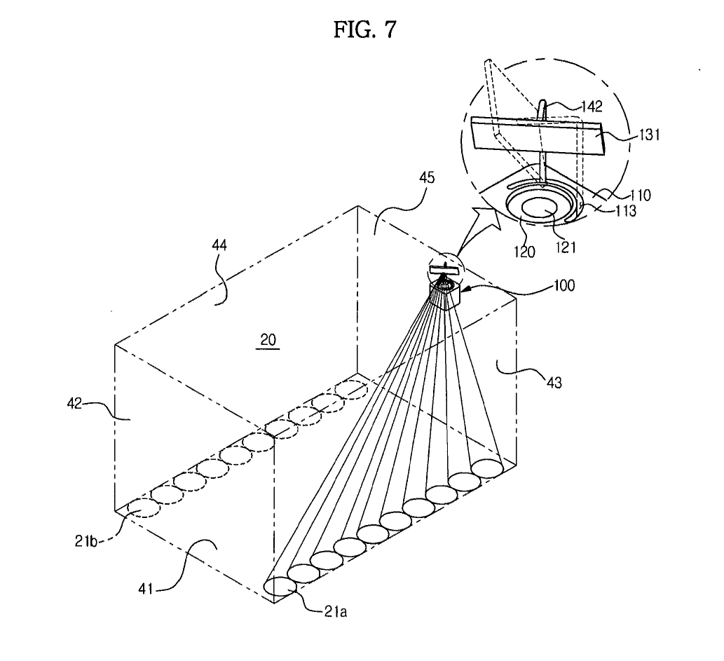

FIG. 7 is a view illustrating operation of the infrared ray detection device in accordance with the embodiment shown in FIGS. 3-5.

Viewing the cooking chamber 20 from the infrared ray detection device 100, as shown in FIG. 7, a region located at the left edge of the bottom surface of the cooking chamber 20 in the widthwise direction of the bottom surface of the cooking chamber 20 is referred to as a first region 21a and a region located at the right edge of the bottom surface of the cooking chamber 20 in the widthwise direction of the bottom surface of the cooking chamber 20 is referred to as a second region 21b. A position of the reflecting mirror 131 shown by the solid line in the enlarged view is a first position, and when the reflecting mirror 131 is located at the first position, a path of infrared rays generated from the first region 21a is changed by the reflecting mirror 131 and then the infrared rays, the path of which has been changed, reach the light reception unit 121 of the infrared ray sensor 120. Further, a position of the reflecting mirror 131 shown by the dotted line in the enlarged view is a second position, and when the reflecting mirror 131 is located at the second position, a path of infrared rays generated from the second region 21b is changed by the reflecting mirror 131 and then the infrared rays, the path of which has been changed, reach the light reception unit 121 of the infrared ray sensor 120.

Both the first region 21a and the second region 21b respectively include a plurality of small sub-regions, and infrared rays generated from the small sub-regions are received by the plural infrared ray detection elements (not shown) disposed in the infrared ray sensor 120.

When the reflecting mirror 131 is located at the first position, the infrared rays generated from the first region 21a are received by the infrared ray sensor 120, and thus an intensity of the infrared rays is measured. A temperature of the first region 21a is calculated using the measured intensity of the infrared rays. The respective small sub-regions in the first region 21a may have different temperatures.

When measurement of the intensity of the infrared rays generated from the first region 21a has been completed, the reflecting mirror 131 is rotated around the rotation axis by a designated angle. Rotation of the reflecting mirror 131 and infrared ray reception of the infrared ray sensor 120 are repeated until the reflecting mirror 131 reaches the second position and an intensity of infrared rays generated from the second region 21b is measured.

When measurement of the intensity of the infrared rays generated from the first region 21a and measurement of the intensity of the infrared rays generated from the second region 21b have been completed, a temperature distribution throughout the bottom surface of the cooking chamber 20 may be calculated.

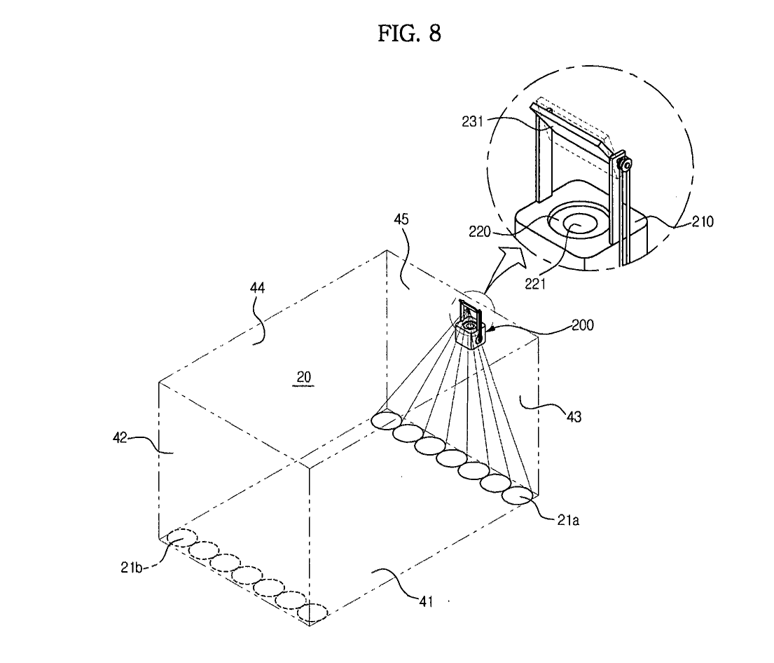

FIG. 8 is a view illustrating operation of the infrared ray detection device in accordance with the embodiment of shown in FIG. 6.

Viewing the cooking chamber 20 from the infrared ray detection device 200, as shown in FIG. 8, a region of the bottom surface of the cooking chamber 20 close to the infrared ray detection device 200 in the lengthwise direction of the bottom surface of the cooking chamber 20 is referred to as a first region 21a and a region of the bottom surface of the cooking chamber 20 distant from the infrared ray detection device 200 in the lengthwise direction of the bottom surface of the cooking chamber 20 is referred to as a second region 21b. A position of the reflecting mirror 231 shown by the solid line in the enlarged view is a first position, and when the reflecting mirror 231 is located at the first position, a path of infrared rays generated from the first region 21a is changed by the reflecting mirror 231 and then the infrared rays, the paths of which have been changed, reach the light reception unit 221 of the infrared ray sensor 220. Further, a position of the reflecting mirror 231 shown by the dotted line in the enlarged view is a second position, and when the reflecting mirror 231 is located at the second position, a path of infrared rays generated from the second region 21b is changed by the reflecting mirror 231 and then the infrared rays, the paths of which have been changed, reach the light reception unit 221 of the infrared ray sensor 220.

Both the first region 21a and the second region 21b respectively include a plurality of small sub-regions, and infrared rays generated from the small sub-regions are received by the plural infrared ray detection elements (not shown) disposed in the infrared ray sensor 220.

When the reflecting mirror 231 is located at the first position, the infrared rays generated from the first region 21a are received by the infrared ray sensor 220, and thus an intensity of the infrared rays is measured. A temperature of the first region 21a is calculated using the measured intensity of the infrared rays. The respective small sub-regions in the first region 21a may have different temperatures.

When measurement of the intensity of the infrared rays generated from the first region 21a has been completed, the reflecting mirror 231 is rotated around the rotation axis by a designated angle. Rotation of the reflecting mirror 231 and infrared ray reception of the infrared ray sensor 220 are repeated until the reflecting mirror 231 reaches the second position and an intensity of infrared rays generated from the second region 21b is measured.

When measurement of the intensity of the infrared rays generated from the first region 21a and measurement of the intensity of the infrared rays generated from the second region 21b have been completed, a temperature distribution throughout the bottom surface of the cooking chamber 20 may be calculated.

As is apparent from the above description, in a heating cooker an infrared ray sensor receives infrared rays generated from food without exposure of the infrared ray sensor to the inside of a cooking chamber. Therefore, contamination of a light reception unit of the infrared ray sensor by oil or steam generated from the food during cooking is prevented and interference due to microwaves is reduced.

Further, a path change unit is rotatable and thus allows infrared rays generated from a plurality of regions of the bottom surface of the cooking chamber in which food is placed, i.e., all regions of the bottom surface of the cooking chamber, to be received by the infrared ray sensor. Therefore, position data of the food are detected simultaneously with measurement of a temperature of the food, and these data are used in cooking of the food.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A heating cooker comprising:
a main body;
an inner case disposed within the main body and having walls defining a cooking chamber; a detection hole formed on one of the walls of the inner case to pass infrared rays generated from the cooking chamber to an outside of the cooking chamber;
a path change unit disposed at the detection hole to change paths of the infrared rays that pass through the detection hole; and
an infrared ray sensor separated from the path change unit by a designated distance to receive the infrared rays, the paths of which have been changed,
wherein the path change unit is movably provided so that infrared rays generated from different regions of the cooking chamber and traveling on different paths are received by the infrared ray sensor.

2. The heating cooker according to claim 1, wherein the separation distance between the path change unit and the infrared ray sensor is maintained when the path change unit is moved.

3. The heating cooker according to claim 1, wherein the detection hole is formed on one of a left wall and a right wall of the inner case and is located closer to an upper wall of the inner case than to a lower wall of the inner case.

4. The heating cooker according to claim 1, wherein the path change unit includes a reflecting mirror to reflect the infrared rays so as to change the paths of the infrared rays.

5. The heating cooker according to claim 1, further comprising a drive device connected to the path change unit to move the path change unit.

6. The heating cooker according to claim 5, wherein the drive device includes a stepping motor to move the path change unit by a designated angle.

7. The heating cooker according to claim 1, wherein the separation distance between the path change unit and the infrared ray sensor is less than 20 mm.

8. The heating cooker according to claim 1, wherein:
the infrared ray sensor includes a light reception unit positioned opposite the path change unit to receive the infrared rays; and
the path change unit is rotated around a virtual rotation axis perpendicular to the light reception unit.

9. The heating cooker according to claim 8, wherein when the path change unit is rotated, infrared rays generated from a region between two opposite edges of a bottom of the cooking chamber are received by the infrared ray sensor.

10. The heating cooker according to claim 1, wherein:
the infrared ray sensor includes a light reception unit positioned opposite the path change unit to receive the infrared rays; and
the path change unit is rotated around a rotation axis perpendicular to a virtual axis perpendicular to the light reception unit.

11. An infrared ray detection device comprising:
a path change unit provided to change paths of infrared rays; and
an infrared ray sensor separated from the path change unit by a designated distance to receive the infrared rays, the paths of which have been changed,
wherein the path change unit is movable so that infrared rays traveling on different paths are received by the infrared ray sensor.

12. The infrared ray detection device according to claim 11, wherein the separation distance between the path change unit and the infrared ray sensor is maintained when the path change unit is moved.

13. The infrared ray detection device according to claim 11, wherein the separation distance between the path change unit and the infrared ray sensor is less than 20 mm.

14. The infrared ray detection device according to claim 11, wherein:
the infrared ray sensor includes a light reception unit positioned opposite the path change unit; and
the path change unit is rotated around a virtual axis perpendicular to the light reception unit.

15. The infrared ray detection device according to claim 11, wherein:
the infrared ray sensor includes a light reception unit positioned opposite the path change unit to receive the infrared rays; and
the path change unit is rotated around a rotation axis perpendicular to a virtual axis, which passes through the light reception unit perpendicularly to the light reception unit.

16. A heating cooker comprising:
a main body;
an inner case disposed within the main body and having sides defining a cooking chamber; a detection hole formed on one of the walls of the inner case to pass infrared rays generated from the cooking chamber to an outside of the cooking chamber;
a path change unit disposed at the detection hole to change paths of the infrared rays that pass through the detection hole; and
an infrared ray sensor separated from the path change unit by a designated distance to receive the infrared rays, the paths of which have been changed, wherein:
the path change unit is movably provided so that infrared rays generated from different regions of the cooking chamber and traveling on different paths are received by the infrared ray sensor; and
the path change unit is moved around a virtual axis perpendicular to the light reception unit.

17. A method of measuring a temperature of a cooking chamber of a heating cooker, including a path change unit disposed at an outside of the cooking chamber and movably provided to change paths of infrared rays generated from the cooking chamber, and an infrared ray sensor to receive the infrared rays, the paths of which have been changed, comprising:
rotating the path change unit to a first position so that infrared rays generated from a first region of the cooking chamber are received by the infrared ray sensor;
rotating the path change unit to a second position so that infrared rays generated from a second region of the cooking chamber are received by the infrared ray sensor;
measuring intensities of the infrared rays generated from the first and second regions that are received by the infrared ray sensor; and
calculating temperatures of the first and second regions using the measured intensities of the infrared rays.
